(19) United States
(12) Patent Application Publication
(10) Pub. No.: US 2025/0295988 A1
(43) Pub. Date: Sep. 25, 2025

(54) GAME SYSTEM, SERVER, AND STORAGE MEDIUM

(71) Applicant: KAWASAKI MOTORS, LTD., Hyogo (JP)

(72) Inventors: Tatsumasa MURAI, Hyogo (JP); Hirotoshi SHIMURA, Hyogo (JP)

(73) Assignee: KAWASAKI MOTORS, LTD., Hyogo (JP)

(21) Appl. No.: 18/611,946

(22) Filed: Mar. 21, 2024

(51) Int. Cl. A63F 13/216; A63F 13/35; A63F 13/5375; A63F 13/69

(52) U.S. Cl. CPC A63F 13/216; A63F 13/35; A63F 13/5375; A63F 13/69

(57) ABSTRACT

A processor of a game system acquires first positional information indicating a position of a mobile terminal that is acquired via a GPS receiver, determines whether the first positional information of the mobile terminal is contained in any of pieces of second positional information respectively corresponding to check points, and provides a reward as content of a game to a player corresponding to the mobile terminal every time the first positional information is contained in any of the pieces of second positional information. A memory stores evaluation corresponding information indicating a correlation between a combination of contents of rewards, and evaluation information including at least one of winning/losing, a ranking, and an earned point of the player in the game. The processor further determines the evaluation information of the player corresponding to the mobile terminal in the game based on the evaluation corresponding information according to the combination of the contents of provided rewards.

### DESCRIPTION

### Technical Field

The present disclosure relates to a game to be executed using a mobile terminal and a server.

### Background

Conventionally, stamp rally systems including a mobile terminal and a server communicable with each other have been known. For example, US Patent Application Publication No. 2004/030756 discloses such a stamp rally system. More specifically, a mobile terminal transmits position information of the mobile terminal acquired via a GPS to a server. The server determines whether the mobile terminal has reached a preset target location of the stamp rally based on this position information. In the following description, the target location of the stamp rally will also be referred to as a check point. When determining that a player holding the mobile phone has reached all of check points, the server transmits an image indicating a coupon for a prize as a reward to the mobile phone.

### SUMMARY

However, the above-described stamp rally system provides the reward only when the player has reached all of the preset check points, thereby being low in game flexibility.

The present specification discloses a game system including a mobile terminal and a server configured to communicate with the mobile terminal. This game system may include a processor and a memory. The mobile terminal may include a GPS receiver. The processor may be configured to acquire first positional information indicating a position of the mobile terminal that is acquired via the GPS receiver, determine whether the first positional information of the mobile terminal is contained in any of pieces of second positional information respectively corresponding to check points, and provide a reward as content of a game to a player corresponding to the mobile terminal every time the first positional information of the mobile terminal is contained in any of the pieces of second positional information. The memory may store evaluation corresponding information indicating a correlation between a combination of contents of rewards, and evaluation information including at least one of winning/losing, a ranking, and an earned point of the player in the game. The processor may be further configured to determine the evaluation information of the player corresponding to the mobile terminal in the game based on the evaluation corresponding information according to the combination of the contents of provided rewards.

According to this game system, the player corresponding to the mobile terminal can acquire the reward every time he/she reaches any of the check points while holding the mobile terminal. Then, the evaluation information (for example, the winning/losing, the ranking, or the point of the player) is determined according to the combination of the contents of the acquired rewards. This means that another factor different from the number of reached check points contributes to the determination of the evaluation information in the game. Therefore, the flexibility of the game can be improved compared to a game system in which the rewards can be acquired when the player reaches all of the check points.

### BRIEF DESCRIPTION OF THE DRAWINGS

FIG. 1 is a block diagram illustrating a schematic configuration of a game system according to one embodiment.

FIG. 2 is a flowchart illustrating a flow of check point setting processing.

FIG. 3 is a flowchart illustrating a flow of game execution processing.

FIG. 4 is a schematic view illustrating one example of a game screen displayed on a mobile terminal.

FIG. 5 is a schematic view illustrating one example of a screen for displaying evaluation information of each player on each mobile terminal.

### DETAILED DESCRIPTION OF THE EMBODIMENTS

In the following description, a game system 10 according to one exemplary embodiment will be described with reference to the drawings. The game system 10 is a system for executing a game entailing a stamp rally factor. In the present embodiment, the game executed by the game system 10 is a draw poker game entailing the stamp rally factor. However, the game executed by the game system 10 can be changed to a poker game following another rule such as Hold'em poker, or another kind of game, instead of the draw poker game. The other kind of game may be, for example, blackjack, Japanese Hanafuda cards, Mahjong, a slot machine, or bingo.

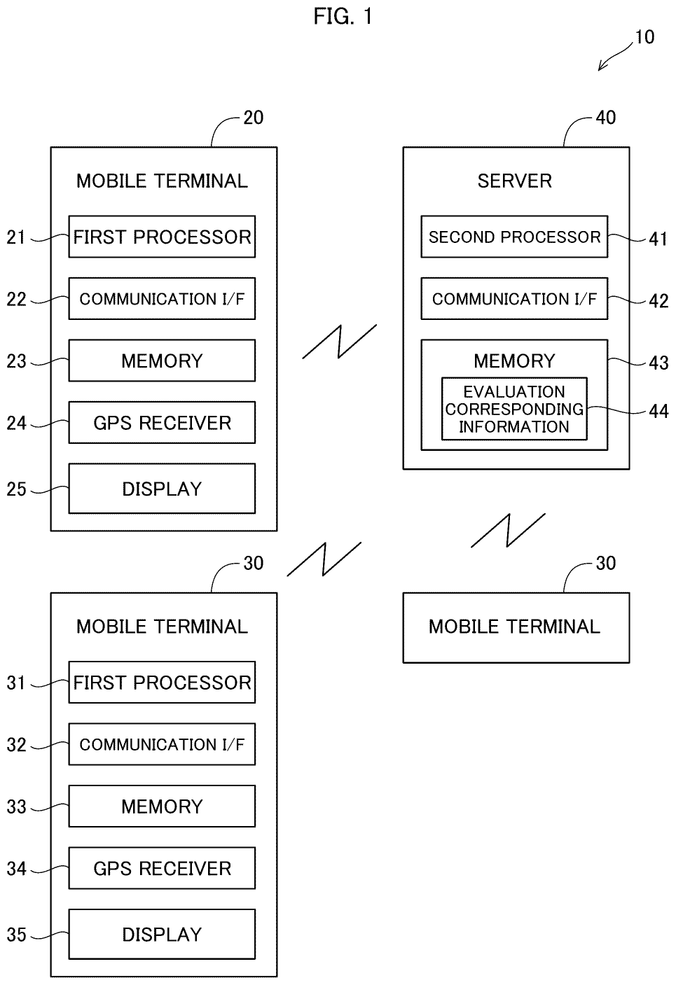

As illustrated in FIG. 1, the game system 10 includes a mobile terminal 20, two mobile terminals 30, and a server 40. Each of the mobile terminals 20 and 30 is typically in the form of a smartphone. Each of the mobile terminals 20 and 30 and the server 40 can wirelessly communicate with each other via a communication line such as the Internet. In the present embodiment, the mobile terminal 20 functions as a host terminal. Therefore, the mobile terminal 20 will also be referred to as a host terminal 20. In the present embodiment, the mobile terminal 30, i.e., a mobile terminal other than the host terminal will also be referred to as a guest terminal 30. The number of guest terminals 30 is not limited to two, and may be any number equal to or larger than one. Further, in a case where the game system 10 includes three or more mobile terminals, the number of host terminals may be two or more.

The host terminal 20 includes a first processor 21, a communication interface 22, a memory 23, a GPS (Global Positioning System) receiver 24, and a display 25. The first processor 21 is a general-purpose processor in the present embodiment, and realizes various functions of the mobile terminal 20 that will be described below by executing a predetermined program stored in the memory 23. The communication interface 22 is an interface for communicating with the server 40. The GPS receiver 24 acquires positional information indicating the current position of the mobile terminal 20 (hereinafter also referred to as first positional information) using GPS. The display 25 is a touch panel-type display, and also functions as a GUI (Graphical User Interface) as widely known.

Each of the guest terminals 30 includes a first processor 31, a communication interface 32, a memory 33, a GPS receiver 34, and a display 35. Because the two guest terminals 30 are similarly configured, FIG. 1 illustrates these components with respect to only one of the guest terminals 30. The guest terminal 30 is basically configured similarly to the host terminal 20. However, the first processor 31 of the guest terminal 30 is different from the first processor 21 of the host terminal 20 in terms of lacking a function specific to the host terminal that is realized by the first processor 21 of the host terminal 20, which will be described below.

The server 40 includes a second processor 41, a communication interface 42, and a memory 43. The second processor 41 is a general-purpose processor in the present embodiment, and realizes various functions of the server 40 that will be described below by executing a predetermined program stored in the memory 43. The communication interface 42 is an interface for communicating with the mobile terminals 20 and 30. Evaluation corresponding information 44 is pre-stored in the memory 43. The details of the evaluation corresponding information 44 will be described below.

In the following description, a method for executing the game by the game system 10 will be described. To execute the game, first, check points are set as a preliminary preparation. In the present embodiment, the check points are set using the host terminal 20. A user of the mobile terminal 20 is also a player of the game in the present embodiment, but may act as an organizer without playing the game.

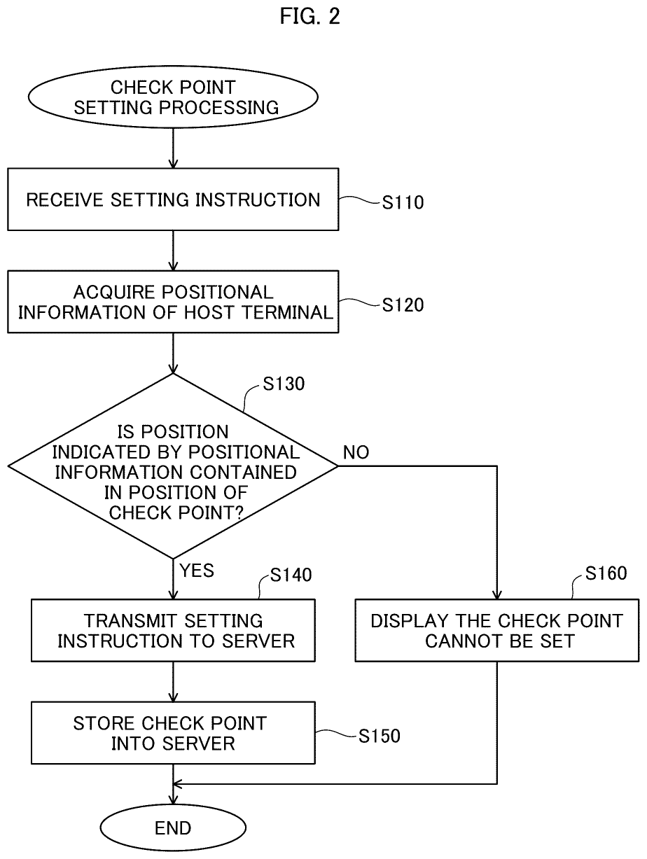

FIG. 2 is a flowchart illustrating a flow of check point setting processing. This processing is started by execution of a predetermined operation by the player of the host terminal 20 on a GUI displayed on the display 25 of the host terminal 20. When the check point setting processing is started, the first processor 21 of the host terminal 20 receives a second instruction, which is an instruction regarding the setting of the check point that is input by the player of the host terminal 20 (step S110). In the following description, the player of the host terminal 20 will also be referred to as a host player. The second instruction is an instruction to set the check point according to the instructed content. In the present embodiment, the instructed content contains information indicating a central position and a positional range of the check point that should be set. This second instruction is a non-limiting example of a “second instruction” defined in the claims.

In the present embodiment, the second instruction is input by the host player in step S110 in the following manner. First, the host player designates the central position of the check point on a map displayed on the display 25 of the host terminal 20. The displayed map data may be provided from a map service on the Internet or may be provided from the server 40. Next, the host player inputs the positional range of the check point via a GUI displayed on the display 25. The positional range of the check point is a radius distance from the central position of the check point in the present embodiment. However, the positional range of the check point may be set to a range having any shape. This radius distance may be input in, for example, a range of 4 m or longer and 50 m or shorter. According to the configuration that allows the positional range of the check point to be set in this manner, the positional range of the check point can be set in consideration of, for example, the accuracy of the GPS receiver or the geography/condition of the location that the host player wants to set as the check point. Alternatively, the check point can be set so as not to include a location that the player should not enter when playing the game, such as a private property. The positional range of the check point input by the host player may be displayed on the map presented on the display 25.

When receiving the second instruction regarding the setting of the check point, the first processor 21 of the host terminal 20 next acquires the positional information indicating the current position of the host terminal 20 via the GPS receiver 24 (step S120). Next, the first processor 21 determines whether the position indicated by the positional information acquired in step S120 is contained in the position expressed by the central position and the positional range of the check point received in step S110 (step S130). Hereinafter, the position expressed by the central position and the positional range of the check point will also be referred to as the position of the check point simply.

If the position indicated by the positional information is contained in the position of the check point as a result of the determination (step S130: YES), the first processor 21 of the host terminal 20 transmits the central position and the positional range of the check point received in step S110 to the server 40 (step S140). Next, the second processor 41 of the server 40 receives the central position and the positional range of the check point, stores them into the memory 43, and sets this position as one of the check points to be set (step S150). At this time, the second processor 41 of the server 40 may transmit a message indicating the completion of the setting to the host terminal 20. In this case, the host terminal 20 may display the received message on the display 25.

On the other hand, if the position indicated by the positional information is not contained in the position of the check point (step S130: NO), the first processor 21 of the host terminal 20 displays a message indicating that the setting of the check point is not permitted on the display 25 (step S160).

After the processing in step S150 or step S160 is ended, the check point setting processing is ended. The check points are sequentially set by repeatedly performing such check point setting processing. The number of check points can be set to any number equal to or greater than the number of rewards required to execute the game, which will be described below, and may be settable to, for example, six or more and ten or less. The first processor 21 of the host terminal 20 may display the positions of all of the set check points on the map displayed on the display 25 all at once.

According to the above-described check point setting processing, the host player can set the check points. Therefore, the flexibility regarding the settings of the check points is improved compared to in case that the check points are set using another information processing apparatus communicable with the server 40.

Further, the first processor 21 of the host terminal 20 accepts the second instruction regarding the setting of the check point if the positional information acquired by the GPS receive 24 is contained in the position of the check point corresponding to the received second instruction, and does not accept the second instruction if the positional information is not contained in the position of the check point corresponding to the received second instruction. In other words, the host player actually visits the location that he/she wants to set as the check point and can set the check point only at this location. This can prevent a location that the game player should not enter, such as a private property, from being set as the check point.

In an alternative embodiment, in step S110, the first processor 21 may receive, as the central position of the check point, a coordinate indicated by the positional information acquired by the GPS receiver 24. In this case, steps S130 and S160 can be omitted.

After the settings of the check points are completed, next, a participant in the game is registered. The registration of a participant in the game is started by first the host player performing a predetermined operation on a GUI displayed on the display 25 of the host terminal 20. When receiving this operation, the first processor 21 of the host terminal 20 generates a game code. The first processor 21 next transmits the game code to the mobile terminal 30 held by a would-be participant in response to a further operation performed by the host player. When the would-be participant starts up a game application stored in the memory 33, inputs the game code and the player name, and performs an operation for requesting participation, the first processor 31 of the mobile terminal 30 transmits a participation request to the server 40. In response thereto, the server 40 assigns identification information to the guest terminal 30, and transmits the participation request of the guest terminal 30 to the host terminal 20 together with this identification information. This participation request is displayed on the display 25 of the host terminal 20. When the host player performs an operation for permitting the participation, the first processor 21 of the host terminal 20 transmits a permission message to the server 40. In response thereto, the second processor 41 of the server 40 registers the identification information of the guest terminal 30 into the memory 43 as a participant in the game. The registration of a participant in the game is completed in this manner. The participant in the game is also registered with the host terminal 20 by a similar procedure.

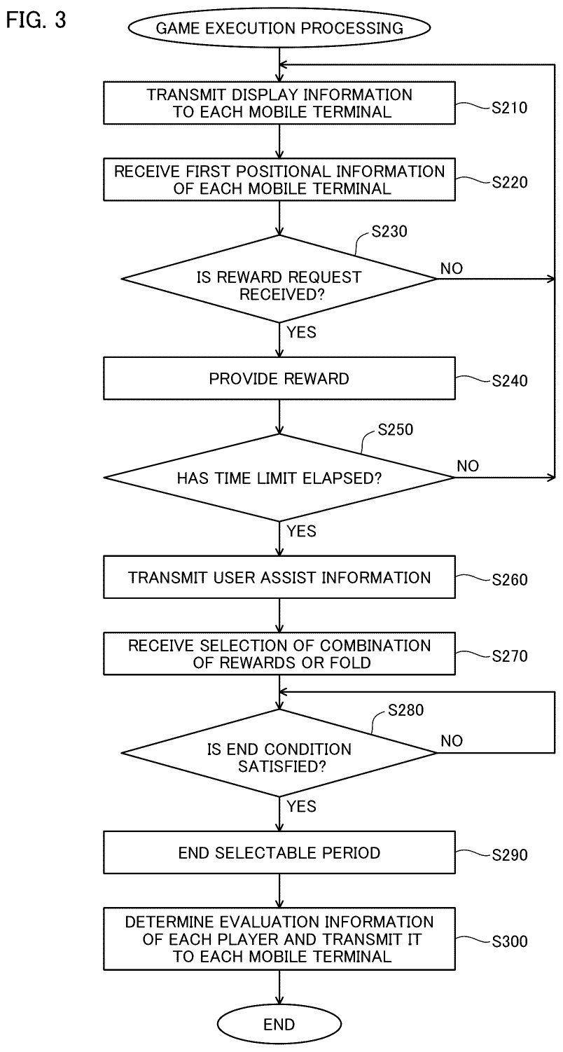

Next, game execution processing in the game system 10 will be described with reference to FIG. 3. The host player operates the host terminal 20 and the first processor 21 of the host terminal 20 transmits a game start request to the server 40 in response thereto, and this triggers a start of the game execution processing. After the game execution processing is started, the second processor 41 of the server 40 transmits display information to each of the mobile terminals 20 and 30 (step S210). This display information is information to be displayed on each of the displays 25 and 35 of the mobile terminals 20 and 30, and includes the positions of the check points, a check point that the player has already reached, the number of remaining check points, and an elapsed time of the game in the present embodiment. The number of remaining check points means the number of check points that the player has not reached yet. In an alternative embodiment, a part of the display information may be acquired by the game application itself in each of the mobile terminals 20 and 30 without the intervention of the server 40, instead of being provided from the server 40 to the mobile terminals 20 and 30. For example, the first processors 21 and 31 of the mobile terminals 20 and 30 may each determine the check point that the player has already reached and the number of remaining check points based on the positions of the check points and a determination method that will be described below, and also determine the elapsed time of the game based on time information held by the first processor 21 or 31 itself.

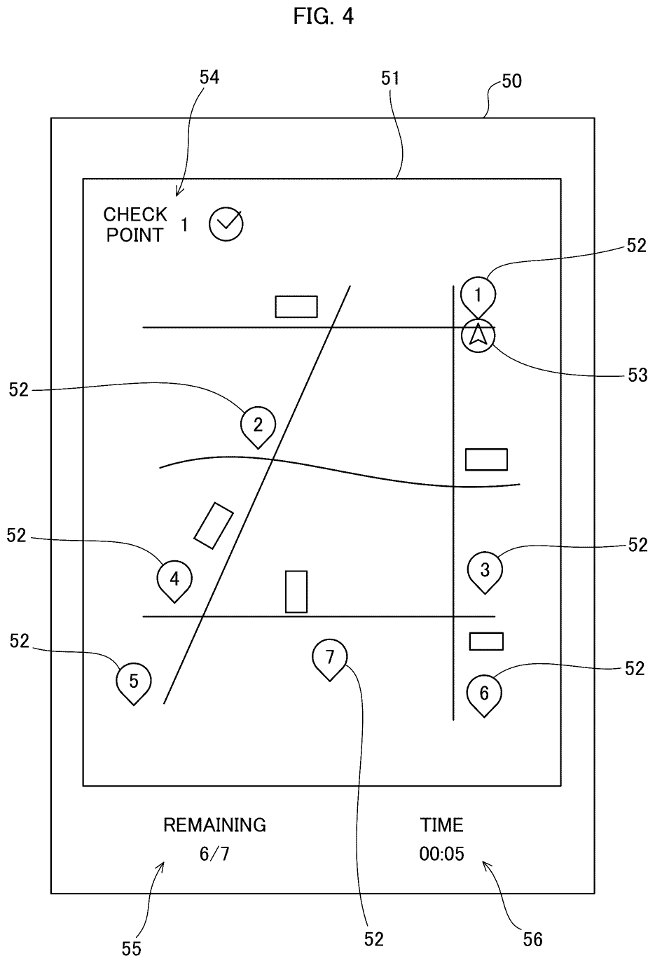

The first processors 21 and 31 of the mobile terminals 20 and 30 each add the first positional information acquired via the GPS receiver 24 or 34, i.e., the position of the player himself/herself and the check point that the player has already reached (the determination method therefor will be described below) to the display information received from the server 40, and display them on the display 25 or 35. FIG. 4 illustrates one example of a game screen displayed on each of the mobile terminals 20 and 30 at this time. As illustrated, a game screen 50 includes a map 51, positions of seven check points 52, a position of the player himself/herself 53, a check point that the player has already reached 54, a number of remaining check points 55, and an elapsed time 56 of the game. This example indicates the display screen presented when the player reaches a check point numbered 1 when five minutes have elapsed since the start of the game.

Next, the second processor 41 of the server 40 transmits a positional information request to each of the mobile terminals 20 and 30, and receives the first positional information indicating the current positional information acquired via the GPS receiver 24 or 34 from each of the mobile terminals 20 and 30 (step S220). In an alternative embodiment, the second processor 41 may receive the first positional information that each of the mobile terminals 20 and 30 regularly transmits to the server 40.

Next, the second processor 41 determines whether a reward request is received from any of the mobile terminals 20 and 30 (step S230). The reward request is transmitted from the mobile terminals 20 and 30 in the following manner. Each of the first processors 21 and 31 of the mobile terminals 20 and 30 determines whether the first positional information of this terminal itself acquired via the GPS receiver 24 or 34 is contained in the range of any of pieces of second positional information respectively corresponding to the check points. The second positional information refers to information indicating the position of the check point, more specifically, information about the position expressed by the central position and the positional range of the check point received from the server 40 and stored in each of the memories 23 and 33. If the first positional information is contained in the range of any of the pieces of second positional information respectively corresponding to the check points as a result of this determination, each of the first processors 21 and 31 transmits the reward request to the server 40.

If the reward request is not received as a result of the determination (step S230: NO), the second processor 41 returns the processing to S210. On the other hand, if the reward request is received (step S230: YES), the second processor 41 of the server 40 provides a reward as content of the game to the player of the corresponding mobile terminal (step S240). In the present embodiment, the reward is a playing card for use in the poker. This reward does not have to be in the form of a card, and may be information usable to display a number and a mark for a card game. The second processor 41 provides one playing card to the player as the reward in the present embodiment, but may provide playing cards. The second processor 41 transmits data of the playing card determined to have to be provided to the corresponding mobile terminal 20 or 30. The first processor 21 or 31 of the mobile terminal 20 or 30 displays the provided playing card on the display 25 or 35 when receiving it.

In an alternative embodiment, in the case where a game such as blackjack, Japanese Hanafuda cards, Mahjong, or a slot machine is employed instead of the poker, the reward may be a playing card, a Hanafuda card, a Mahjong tile, or a symbol used in the corresponding game. Alternatively, in the case where a bingo game is employed instead of the poker, the reward may be a number arranged in a square of the bingo card.

In the present embodiment, the second processor 41 randomly provides one of pre-prepared rewards having contents different from one another. More specifically, the second processor 41 randomly provides one of fifty-two kinds of playing cards to the player. The second processor 41 stores the kind of playing card provided to the player into the memory 43 in association with the identification information of the mobile terminal 20 or 30.

In an alternative embodiment, the second processor 41 of the server 40 may determine whether the first positional information received in step S220 is contained in the range of any of the pieces of second positional information respectively corresponding to the check points with respect to each of the mobile terminals 20 and 30 instead of step S230. In this case, if the first positional information is not contained in the range of any of the pieces of second positional information, the second processor 41 returns the processing to step S210. On the other hand, if the first positional information is contained in the range of any of the pieces of second positional information, the second processor 41 advances the processing to step S240.

Next, the second processor 41 of the server 40 determines whether a predetermined time limit has elapsed (step S250). This time limit is a time limit for collecting playing cards. The time limit may be set by the host terminal 20 before the game starts. If the time limit has not elapsed as a result of the determination (step S250: NO), the second processor 41 returns the processing to step S210. The player can acquire a new kind of playing card every time he/she newly reaches any of the check points by repeating such a cycle from step S210 to step S250.

According to the configuration that randomly provides one of the fifty-two kinds of playing cards to the player, not only the number of check points that the player has reached but also a luck factor are expected to be additionally reflected in what kind of playing cards are owned by each player. As a result, a chance to win the game can be further equally opened up to many participants. However, the second processor 41 may provide predetermined kinds of playing cards to each player in a predetermined order.

In the present embodiment, the first processors 21 and 31 of the mobile terminals 20 and 30 each display the acquired playing cards on the display 25 or 35 so as to be set out. According to this configuration, the player can easily understand a combination of playing cards to create a hand in the poker.

In the present embodiment, the upper limit on the number of acquirable playing cards is equal to the number of check points, and seven in the case of the example illustrated in FIG. 4. However, the upper limit on the number of acquirable playing cards may be set irrespectively of the number of check points. In this case, the second processor 41 of the server 40 prohibits a new playing card from being provided to a player that has acquired the number of playing cards reaching the upper limit. According to this configuration, a chance to win the game can be further equally opened up even to a player having no time to reach all of the check points.

On the other hand, if the time limit has elapsed (step S250: YES), the second processor 41 of the server 40 transmits user assist information regarding a selection of a combination of playing cards to each of the mobile terminals 20 and 30 (step S260). The user assist information includes a combination pattern of playing cards that can create a hand. If hands can be created, the user assist information may include information regarding the strength of each hand. The first processors 21 and 31 of the mobile terminals 20 and 30 each display the user assist information received from the server 40 on the display 25 or 35. The transmission timing and the content of the user assist information are not limited to the above-described examples, and can be set in any manner. For example, the second processor 41 may transmit the user assist information including information regarding a possible hand almost to be achieved and a number and a mark of a playing card necessary to be further acquired for this hand, when four playing cards are acquired.

Next, the second processor 41 of the server 40 receives a first instruction regarding the selection of the combination of playing cards that should be used to calculate evaluation information, which will be described below (step S270). In the present embodiment, the first instruction includes a selection instruction regarding the combination of playing cards or an instruction to select “FOLD”. The selection instruction regarding the combination of playing cards refers to an instruction about which five cards are used to create a hand among seven playing cards, which is the maximum number of playing cards that the player can collect, in the example illustrated in FIG. 4. This first instruction is a non-limiting example of a “first instruction” in the claims. The first processors 21 and 31 of the mobile terminals 20 and 30 each receive an input from the player and transmit it to the server 40, by which the first instruction is acquired by the second processor 41. The second processor 41 stores the acquired combination of playing cards into the memory 43 in association with the identification information of the mobile terminal 20 or 30. The first processors 21 and 31 of the mobile terminals 20 and 30 may each display the playing cards, from which the player should make the selection, to be set out and also display the user assist information along therewith on the same screen, when receiving the input from the player.

According to this configuration, the player can select the combination of playing cards that should be used to create a hand or whether to select “FOLD” on his/her own. As a result, the factor of a player's selection to create a hand is added besides the number of reached check points and the luck factor, and therefore the game can become further exciting. Further, the player can select the combination of playing cards so as to create a further strong hand by referring to the user assist information even if being unfamiliar with the rules of the poker game.

Next, the second processor 41 of the server 40 determines whether an end condition regarding a period during which the combination of cards or “FOLD” is selectable is satisfied (step S280). In the present embodiment, the end condition is determined based on whether a predetermined operation is performed on each of the mobile terminals 20 and 30. The predetermined operation is a selection operation regarding the combination of playing cards or an operation of selecting “FOLD” on each of the mobile terminals 20 and 30. The second processor 41 determines that the predetermined operation is performed on each of the mobile terminals 20 and 30 when receiving the instruction from each of all the mobile terminals 20 and 30 in step S270.

If the end condition is not satisfied as a result of the determination (step S280: NO), the second processor 41 waits until the end condition is satisfied. On the other hand, if the end condition is satisfied (step S280: YES), the second processor 41 ends the selectable period (step S290). In this case, the second processor 41 transmits a selectable period end notification to each of the mobile terminals 20 and 30. Upon receiving the selectable period end notification, the first processors 21 and 31 of the mobile terminals 20 and 30 each display the selectable period end notification on the display 25 or 35 and also prohibit the instruction to select the combination of playing cards or “FOLD” from being received after that. Each player can easily understand the progress status of the game with the aid of the selectable period end notification displayed in this manner.

According to this configuration, the selectable period can be further freely set. For example, the timing of ending the selectable period can be further freely determined according to the user's operation status compared to in case that an elapse of a predetermined time is set as the timing of ending the selectable period. For example, the present configuration prevents occurrence of a waiting time lasting until the predetermined time has elapsed despite the completion of the required operation by all the players.

In an alternative embodiment, the end condition may be set to an elapse of a predetermined time instead of the condition based on the status of the predetermined operation on each of the mobile terminals 20 and 30. In this case, the first processors 21 and 31 of the mobile terminals 20 and 30 may each display a remaining time left to satisfy the end condition on the display 25 or 35.

In a further alternative embodiment, the end condition may be set to an elapse of a predetermined time in addition to the condition based on the status of the predetermined operation on each of the mobile terminals 20 and 30. In this case, the second processor 41 of the server 40 may end the selectable period upon the satisfaction with at least one of the execution of the predetermined operation on each of the mobile terminals 20 and 30 and the elapse of the predetermined time. According to this alternative embodiment, the smooth progress of the game can be facilitated without the selectable time excessively increasing due to a specific player who takes a long time to make the selection.

In a further alternative embodiment, the end condition may be settable on the host terminal 20. In this case, the first processor 21 of the host terminal 20 transmits an end condition input by the host player to the server 40 in response to an operation performed by the host player, and the second processor 41 of the server 40 sets the received end condition. In such an input operation, the first processor 21 of the host terminal 20 may selectably display at least one of the above-described two conditions on the display 25. According to this alternative embodiment, the selectable period can be set further flexibly.

In a further alternative embodiment, the first processor 21 of the host terminal 20 may receive an instruction to change the setting of the end condition in the middle of the game in progress. According to this alternative embodiment, the setting of the selectable period can be changed according to the progress status of the game. For example, the host player can change the end condition from the condition based on the status of the predetermined operation on each of the mobile terminals 20 and 30 to the elapse of the predetermined time when a specific player takes a long time to make the selection.

Subsequently, the second processor 41 of the server 40 refers to the evaluation corresponding information 44 stored in the memory 43 to determine evaluation information of each player according to the combination of playing cards selected by each player, and transmits the evaluation information to each of the mobile terminals 20 and 30 (step S300).

In the present embodiment, the evaluation information is a ranking according to the strength/weakness of the poker hand. The evaluation corresponding information 44 is information indicating a correlation between the combination of playing cards and the ranking indicating the strength/weakness of the poker hand. However, the evaluation information may be at least one of the winning/losing, the ranking, and the earned point of the player in the game depending on the type of the game executed in the game system 10. For example, the evaluation information may be the winning/losing in the case of a bingo game and may be the point calculated based on the achieved hand in the case of a Mahjong game. Similarly, the evaluation corresponding information 44 may be any information indicating a correlation between a combination of contents of rewards, and the evaluation information including at least one of the winning/losing, the ranking, and the point of the player in the game depending on the type of the game executed in the game system 10.

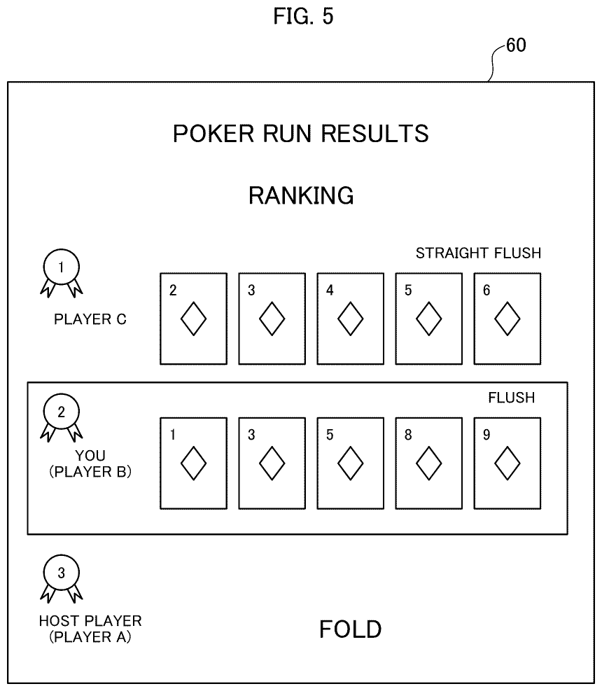

In the present embodiment, in step S300, the second processor 41 transmits the pieces of evaluation information of all of the players to each player. The first processors 21 and 31 of the mobile terminals 20 and 30 each display the received pieces of evaluation information of all of the players on the display 25 or 35. FIG. 5 illustrates one example of a display screen presenting the pieces of evaluation information of all of the players. The combination of playing cards of one player himself/herself, and the combinations of playing cards of the other players are displayed so as to be set out, and, further, the ranking based on the hand is displayed on the display screen 60. According to this configuration, each player can easily compare the evaluation information of the other players and the evaluation information of the player himself/herself, and thus easily becomes aware of whether he/she wins or loses the game.

In an alternative embodiment, the second processor 41 of the server 40 may transmit the combination of contents of the rewards provided to the other players to each player in the middle of the game, i.e., before the winning/losing is determined depending on the type of the game executed in the game system 10. The first processors 21 and 31 of the mobile terminals 20 and 30 each display the received combinations of contents of the rewards of all of the players on the display 25 or 35. According to this configuration, for example, in the case of a bingo game, each player can enjoy the bingo game while confirming the progress status of activation of bingo squares by the other players, which proceeds based on a number randomly extracted by the server 40.

In a further alternative embodiment, the host terminal 20 may be set whether to display or hide the evaluation information of the other players on the guest terminal 30. In this case, the first processor 21 of the host terminal 20 transmits a setting instruction input by the host player to the server 40 in response to an operation performed by the host player. When receiving a setting instruction to hide the evaluation information, the second processor 41 of the server 40 does not transmit the evaluation information of the other players to players other than the host player in step S300. As a result, the guest terminal 30 displays only the evaluation information of the player himself/herself thereon. According to this configuration, a stage to announce the result of the game can be set separately, and therefore the game system 10 can make the players enjoy the game in a further flexible manner.

According to the above-described game system 10, each player can acquire a playing card used in the poker game every time he/she reaches one of the check points. Then, the ranking is determined according to the combination of the acquired playing cards. This means that another factor different from the number of reached check points contributes to the determination of the ranking in the game. Therefore, the flexibility of the poker game can be improved compared to a game system in which playing cards can be acquired when a player reaches all of the check points. For example, the game system 10 can open up a chance to win the game further equally to many participants, thereby easily encouraging the participant's willingness to join.

The game system 10 further has a function for an administrator. Now, such a function will be described. The second processor 41 of the server 40 transmits the first positional information acquired in step S220, i.e., the positional information of each of the mobile terminals 20 and 30 to the host terminal 20. When receiving this positional information, the first processor 21 of the host terminal 20 displays the mapped position of each of the mobile terminals 20 and 30 on the display 25. According to this configuration, the host player can easily understand the current position of the player of each of the mobile terminals 20 and 30. Therefore, for example, the host player can easily confirm each player's progress in reaching the check points. Alternatively, the host player can monitor whether each player stays off a restricted area. The restricted area is, for example, a private property or a construction site.

In the present embodiment, the second processor 41 of the server 40 transmits the positional information of each of the mobile terminals 20 and 30 to the host terminal 20 in association with the identification information of the corresponding terminal. The first processor 21 of the host terminal 20 displays, based on the identification information received from the server 40, the mapped position of each of the mobile terminals 20 and 30 on the display 25 so as to make each player identifiable. Therefore, the host player can easily understand who is associated with each positional information displayed on the display 25.

Further, in the present embodiment, the first processor 21 of the host terminal 20 receives a third instruction regarding the setting of the restricted area that is input by the host player. This third instruction is an instruction to set the restricted area according to the specified content, and includes third positional information corresponding to the restricted area. In the present embodiment, the specified content contains information about the center and the positional range of the restricted area that should be set. The third instruction is a non-limiting example of a “third instruction” in the claims. The input regarding the restricted area from the host player may be realized based on, for example, a similar method to the above-described second instruction regarding the setting of the check point (refer to step S110). Alternatively, the input regarding the restricted area from the host player may be realized by designating an area that should be set as the restricted area on the map displayed on the display 25 of the host terminal 20.

The first processor 21 further displays the mapped position of each of the mobile terminals 20 and 30 on the display 25 so as to make identifiable whether they are located in the restricted area. In the present embodiment, the first processor 21 may display the first positional information, i.e., the position of each of the mobile terminals 20 and 30, and the third positional information, i.e., the position of the restricted area on the display 25 all at once. According to this configuration, the host player can easily identify whether the position of each of the mobile terminals 20 and 30 is located in the restricted area. According to this configuration, the host player can easily become aware of whether any of the players enters the preset restricted area.

The first processor 21 further determines whether the position of each of the mobile terminals 20 and 30 is located in the restricted area. In an alternative embodiment, the first processor 21 may display the first positional information but refrain from displaying the third positional information on the display 25, instead of being configured to display the first positional information and the third positional information on the display 25 all at once. In this case, the first processor 21 may determine whether the position of each of the mobile terminals 20 and 30 is located in the restricted area, and display a result of this determination on the display 25 together with the first positional information.

When the position of any of the mobile terminals 20 and 30 is located in the restricted area, the first processor 21 performs alert processing. The alert processing may be implemented in the form of, for example, displaying an alert message on the display 25 or highlighting the position of the mobile terminal 20 or 30 located in the restricted area.

The first processor 21 of the host terminal 20 may transmit the third positional information corresponding to the restricted area to the server 40. In this case, the second processor 41 of the server 40 may transmit the third positional information corresponding to the restricted area to the guest terminal 30, and the first processor 31 of the guest terminal 30 may display the received third positional information corresponding to the restricted area on the display 35. The third positional information may be displayed here in a similar manner to the display of the restricted area on the host terminal 20. According to this configuration, each player can be headed to a check point while confirming that the player himself/herself does not enter the restricted area.

The first processor 21 further displays a movement history of each player on the display 25 based on the positional information of each of the mobile terminals 20 and 30 received from the server 40. According to this configuration, the movement history of each player can be easily tracked.

Having described several embodiments of the present invention, the above-described embodiments are intended to facilitate an understanding of the present invention, and are not intended to limit the present invention thereto. The present invention can be modified or improved without departing from the spirit thereof, and the present invention includes equivalents thereof. Further, each of the forms/elements described in the claims and the specification can be combined or omitted in any manner within a range that allows it to remain capable of achieving at least a part of the above-described objects or bringing about at least a part of the above-described advantageous effects.

Further, the present invention can be embodied in various forms, such as a mobile terminal, a server, a method for executing a game using a mobile terminal and a server, a computer program for a mobile terminal or a server, and a non-transitory storage medium storing this program in a computer-readable manner, besides the above-described game system. The storage medium may be either a single storage medium or storage media in which the program is stored in a distributed manner.

The functionality of the elements disclosed herein may be implemented using circuitry or processing circuitry which includes general purpose processors, special purpose processors, integrated circuits, ASIC (“Application Specific Integrated Circuit”), conventional circuitry, and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The above-described flowcharts are merely examples, and each of the processing procedures included in the flowcharts can be subjected to a change in the processing order therein and/or be changed to equivalent processing within a range that does not depart from the spirit of the present invention.

The number of mobile terminals in the game system 10 is not limited to a plural number, and may be a singular number. In this case, the second processor 41 of the server 40 may provide a virtual player serving as an opponent against the player of the mobile terminal.

The player may reach the access point by walking, or may reach in a state of riding on various kinds of vehicles. Such a vehicle may be, for example, a four-wheeled vehicle, a two-wheeled vehicle, a jet ski bike, or a ship or a boat.

The game system 10 can be modified in such a manner that a part of the above-described various functions of the server 40 is fulfilled by the mobile terminal(s) 20 and/or 30. Alternatively, the game system 10 can be modified in such a manner that a part of the above-described various functions of the mobile terminals 20 and 30 is fulfilled by the server 40.

The present invention can be embodied as the following embodiments. Various embodiments that will be described next are not essential to the present invention, and can also be combined with any other embodiment in any manner.

In one or more embodiment(s), a game system including a mobile terminal and a server configured to communicate with the mobile terminal may include a processor and a memory. The processor may include a first processor included in the mobile terminal and a second processor included in the server. In this case, functions realized by the processor of the game system may be distributed into a function of the first processor and a function of the second processor. In other words, the first processor and the second processor may cooperate with each other to realize each function of the “processor.”

In one or more embodiment(s), the processor may be further configured to randomly provide one of pre-prepared rewards having contents different from one another to the player of the mobile terminal. According to this embodiment, a luck factor is additionally reflected in how the contents of the rewards are combined, based on which the evaluation information is determined. As a result, a chance to win the game can be further equally opened up to many participants.

In one or more embodiment(s), the mobile terminal may include mobile terminals each equipped with a display. The processor may include first processors respectively included in the mobile terminals, and a second processor included in the server. The second processor may be configured to transmit at least one of the combination of the contents of the rewards provided to each of players respectively corresponding to the mobile terminals, and the evaluation information of each of the players respectively corresponding to the mobile terminals to each of the mobile terminals. Each of the first processors may be configured to output, on the display, the at least one of the combination of the contents of the rewards provided to each of the players respectively corresponding to the mobile terminals, and the evaluation information of each of the players, which is received from the second processor. According to this embodiment, each of the players respectively corresponding to the mobile terminals can easily understand at least one of the combination of the contents of the rewards provided to each of the players and the evaluation information of each of the players depending on the type of the game. Therefore, the user-friendliness of the game is improved.

In one or more embodiment(s), the processor may include a first processor included in the mobile terminal. The first processor may be configured to receive a first instruction regarding a selection of the combination of the rewards to be used to calculate the evaluation information among provided rewards. According to this embodiment, the player can select the combination of the rewards that should be used to calculate the evaluation information on his/her own. Therefore, the factor of a player's selection is additionally reflected in how the contents of the rewards are combined, based on which the evaluation information is determined. As a result, the game can become further exciting.

In one or more embodiment(s), the mobile terminal may further include a display. The first processor may be further configured to output user assist information regarding the selection of the combination of the rewards on the display. According to this embodiment, the player can select the combination of the rewards that should be used to calculate the evaluation information by referring to the user assist information. Therefore, even if the player is unfamiliar with the rules of the game, the player can correctly select the combination of the contents of the rewards, based on which the evaluation information is determined, i.e., can select the combination so as to acquire higher evaluation information.

In one or more embodiment(s), the mobile terminal may include mobile terminals. The processor may include a second processor included in the server. The second processor may be configured to determine, based on communication with the first processors, whether an end condition based on whether a predetermined operation is performed on each of the mobile terminals is satisfied, and end a period during which the combination of the rewards to be used to calculate the evaluation information is selectable when determining that the end condition is satisfied. According to this embodiment, the period during which the combination of the rewards that should be used to calculate the evaluation information is selectable can be further freely set. For example, the timing of ending the selectable period can be further freely determined according to the user's operation status compared to in case that an elapse of a predetermined time is set as the timing of ending the selectable period. In other words, the present embodiment can prevent occurrence of a waiting time lasting until the predetermined time has elapsed despite the completion of the required operation by all the players.

In one or more embodiment(s), the mobile terminal may include mobile terminals. At least one of the mobile terminals may be a host terminal including a first processor. The first processor of the host terminal may be configured to receive a second instruction regarding a setting of each of the check points. According to this embodiment, the second instruction may include a central position and a positional range of each of the check points to be set. According to this embodiment, the player corresponding to the host terminal can set the check points. Therefore, the flexibility regarding the settings of the check points is improved. In addition, the flexibility regarding the settings of the check points is improved. The positional range of the check point can be set in consideration of, for example, the accuracy of the GPS receiver or the geography/condition of the location that the player of the host terminal wants to set as the check point.

In one or more embodiment(s), the first processor of the host terminal may be further configured to accept the second instruction when the position indicated by the positional information acquired by the GPS receiver of the host terminal is contained in a position indicated by the central position and the positional range of the check point. According to this embodiment, the player of the host terminal actually visits the locations that he/she wants to set as the check points, and can set each of the check points by inputting the second instruction regarding each of the settings of the check points to the host terminal only at the locations. Therefore, this embodiment can prevent a location that the player should not enter, such as a private property, from being set as the check point.

In one or more embodiment(s), the mobile terminal may include mobile terminals. The processor may include first processors respectively included in the mobile terminals, and a second processor included in the server. At least one of the mobile terminals may be a host terminal including a display. The second processor may be configured to receive the first positional information from each of the mobile terminals, and transmit the first positional information of each of the mobile terminals to the first processor of the host terminal. The first processor of the host terminal may be configured to receive the first positional information of each of the mobile terminals from the second processor and output the first positional information on the display. According to this embodiment, the player of the host terminal can easily understand the current position of the player of each of the mobile terminals. Therefore, for example, the player of the host terminal can easily confirm each player's progress in reaching the check points. Alternatively, the player of the host terminal can easily become aware of whether any of the players enters a location that the players should not enter.

In one or more embodiment(s), the processor may be further configured to assign identification information to each of the mobile terminals that participates in the game. The first processor of the host terminal may be further configured to output, based on the identification information, the first positional information of each of the mobile terminals on the display so as to make players respectively corresponding to the mobile terminals identifiable. According to this embodiment, the player of the host terminal can easily understand the current position of the player of each of the mobile terminals in association with each player.

In one or more embodiment(s), the first processor of the host terminal may be further configured to receive a third instruction regarding a setting of a restricted area, and output the first positional information of each of the mobile terminals on the display so as to make identifiable whether the first positional information of each of the mobile terminals is contained in third positional information corresponding to the restricted area. According to this embodiment, the player of the host terminal can easily become aware of whether any of the players enters the preset restricted area, such as a private property.

In one or more embodiment(s), the first processor of the host terminal may be further configured to output a movement history of each of the mobile terminals on the display based on the first positional information of each of the mobile terminals that is received from the second processor. According to this embodiment, the player of the host terminal can easily track the movement history of the player of each of the mobile terminals. Therefore, for example, the player of the host terminal can easily become aware of whether any of the players has ever entered a location that the players should not enter.

### DESCRIPTION OF THE REFERENCE NUMERALS

10 game system, 20 mobile terminal (host terminal), 21 first processor, 22 communication interface, 23 memory, 24 GPS receiver, 25 display, 30 mobile terminal (guest terminal), 31 first processor, 32 communication interface, 33 memory, 34 GPS receiver, 35 display, 40 server, 41 second processor, 42 communication interface, 43 memory, 44 evaluation corresponding information, 50 game screen, 52 check point, 53 position, 54 reached check point, 56 elapsed time, 60 display screen

1. A game system including a mobile terminal and a server configured to communicate with the mobile terminal, the game system comprising:
a processor; and
a memory,
wherein the mobile terminal including a GPS receiver,
the processor is configured to
acquire first positional information indicating a position of the mobile terminal that is acquired via the GPS receiver,
determine whether the first positional information of the mobile terminal is contained in any of pieces of second positional information respectively corresponding to check points, and
provide a reward as content of a game to a player corresponding to the mobile terminal every time the first positional information of the mobile terminal is contained in any of the pieces of second positional information,
the memory stores evaluation corresponding information indicating a correlation between a combination of contents of rewards, and evaluation information including at least one of winning/losing, a ranking, and an earned point of the player in the game, and
the processor is further configured to determine the evaluation information of the player corresponding to the mobile terminal in the game based on the e valuation corresponding information according to the combination of the contents of provided rewards.

2. The game system according to claim 1, wherein the processor is further configured to randomly provide one of pre-prepared rewards having contents different from one another to the player of the mobile terminal.

3. The game system according to claim 1, wherein the mobile terminal includes mobile terminals each equipped with a display,
the processor includes first processors respectively included in the mobile terminals, and a second processor included in the server,
the second processor is configured to transmit at least one of the combination of the contents of the rewards provided to each of players respectively corresponding to the mobile terminals, and the evaluation information of each of the players respectively corresponding to the mobile terminals to each of the mobile terminals, and
each of the first processors is configured to output, on the display, the at least one of the combination of the contents of the rewards provided to each of the players respectively corresponding to the mobile terminals, and the evaluation information of each of the players, which is received from the second processor.

4. The game system according to claim 1, wherein the processor includes a first processor included in the mobile terminal, and
the first processor is configured to receive a first instruction regarding a selection of the combination of the rewards to be used to calculate the evaluation information among the provided rewards.

5. The game system according to claim 4, wherein the mobile terminal further includes a display, and
the first processor is further configured to output user assist information regarding the selection of the combination of the rewards on the display.

6. The game system according to claim 4, wherein the mobile terminal includes mobile terminals,
the processor includes a second processor included in the server, and
the second processor is configured to
determine, based on communication with the first processors, whether an end condition based on whether a predetermined operation is performed on each of the mobile terminals is satisfied, and
end a period during which the combination of the rewards to be used to calculate the evaluation information is selectable when determining that the end condition is satisfied.

7. The game system according to claim 1, wherein the mobile terminal includes mobile terminals,
at least one of the mobile terminals is a host terminal including a first processor,
the first processor of the host terminal is configured to receive a second instruction regarding a setting of each of the check points, and
the second instruction includes a central position and a positional range of the check point to be set.

8. The game system according to claim 7, wherein the first processor of the host terminal is further configured to accept the second instruction when the position indicated by the positional information acquired by the GPS receiver of the host terminal is contained in a position indicated by the central position and the positional range of the check point.

9. The game system according to claim 1, wherein the mobile terminal includes mobile terminals,
the processor includes first processors respectively included in the mobile terminals, and a second processor included in the server,
at least one of the mobile terminals is a host terminal including a display,
the second processor is configured to receive the first positional information from each of the mobile terminals, and transmit the first positional information of each of the mobile terminals to the first processor of the host terminal, and
the first processor of the host terminal is configured to receive the first positional information of each of the mobile terminals from the second processor and output the first positional information on the display.

10. The game system according to claim 9, wherein the processor is further configured to assign identification information to each of the mobile terminals that participates in the game, and
the first processor of the host terminal is further configured to output, based on the identification information, the first positional information of each of the mobile terminals on the display so as to make players respectively corresponding to the mobile terminals identifiable.

11. The game system according to claim 9, wherein the first processor of the host terminal is further configured to
receive a third instruction regarding a setting of a restricted area, and
output the first positional information of each of the mobile terminals on the display so as to make identifiable whether the first positional information of each of the mobile terminals is contained in third positional information corresponding to the restricted area.

12. The game system according to claim 9, wherein the first processor of the host terminal is further configured to output a movement history of each of the mobile terminals on the display based on the first positional information of each of the mobile terminals that is received from the second processor.

13. A server comprising:
a processor; and
a memory,
wherein the processor is configured to provide a reward as content of a game to a player corresponding to a mobile terminal every time first positional information of the mobile terminal acquired via a GPS receiver is contained in any of pieces of second positional information respectively corresponding to check points,
the memory stores evaluation corresponding information indicating a correlation between a combination of contents of rewards, and evaluation information including at least one of winning/losing, a ranking, and an earned point of the player in the game, and
the processor is further configured to determine the evaluation information of the player corresponding to the mobile terminal in the game based on the evaluation corresponding information according to the combination of the contents of provided rewards.

14. A non-transitory storage medium storing therein a program for causing a computer to perform processing in a computer-readable manner, the processing comprising:
providing a reward as content of a game to a player corresponding to a mobile terminal every time first positional information of the mobile terminal that is acquired via a GPS receiver is contained in any of pieces of second positional information respectively corresponding to check points,
wherein the storage medium stores evaluation corresponding information indicating a correlation between a combination of contents of rewards, and evaluation information including at least one of winning/losing, a ranking, and an earned point of the player in the game, and
the processing further comprising determining the evaluation information of the player corresponding to the mobile terminal in the game based on the evaluation corresponding information according to the combination of the contents of provided rewards.
